(19) United States
(12) Patent Application Publication
(10) Pub. No.: US 2005/0084826 A1
(43) Pub. Date: Apr. 21, 2005

(54) Tooth whitening and image enhancement center method

(76) Inventors: Anthony M. Pilaro, Gstaad (CH); John W. Warner, Warner, NH (US); Robert Eric Montgomery, Lee, MA (US); Anthony J. Cipolla, Trout Run, PA (US); John L. Reed, Honolulu, HI (US); Salim A. Nathoo, Piscataway, NJ (US)

Correspondence Address: MAYER, BROWN, ROWE & MAW LLP, 190 SOUTH LASALLE ST, CHICAGO, IL, 60603-3441, US

(21) Appl. No.: 10/969,532

(22) Filed: Oct. 20, 2004

Related U.S. Application Data
(63) Continuation of application No. 09/483,526, filed on Jan. 14, 2000.

(51) Int. Cl. A61C 5/00

(52) U.S. Cl. 433/215

(57) ABSTRACT

A tooth whitening service module and an associated procedure for whitening teeth that can efficiently handle a large number of clients. The method involves whitening a client's teeth in a tooth whitening service module that provides a discrete infrastructure dedicated to performing the tooth whitening procedure. The tooth whitening procedure is performed on two or more clients simultaneously, thus allowing for treatment of a large volume of clients as they flow through the tooth whitening service module.

The invention relates to a method of providing tooth whitening services to a large number of clients within a single physical or geographical location.

### BACKGROUND OF THE INVENTION

Non-restorative dental treatments to whiten, lighten, and/or bleach teeth have been of interest for more than one hundred years. See Zaragoza, EstoModeo, 9, 7-30 (1984). Within the last ten years, the demand for this type of elective dental care has grown dramatically, fueled by the aging and image conscious “baby boom” generation, increased public awareness, and availability of other medical/dental cosmetic procedures.

Most modern whitening technologies are derived from work done in the late 1800's, when the first experiments using hydrogen peroxide to whiten teeth were performed. Zaragoza (1984). In the early 1900s, the first use of hydrogen peroxide with light was recorded. Zack et al., Oral Surg. OraL Med. OraL Pathol, 19, 515-530 (1965). Over the years various, other heat and light sources (including lasers) have been used with hydrogen peroxide solutions. Reports of whitening non-vital teeth with hydrogen peroxide and heated instruments appear as early as the 1950s (see Sakaguchi et al. in Hardin et at, ed., “Bleaching of Vital Teeth,” Clark's Clinical Dentistry, vol. 4, Philadelphia: Lippincott, 1-19 (1991), and the “walking bleach” technique (utilizing hydrogen peroxide and sodium perborate) was introduced in 1976. See Nutting et at, Dent Clin North Am., 10, 655-662 (1976). However, most of these “in-office” whitening techniques required much time, multiple visits to a dental practitioner, rubber dams, and were costly. Moreover, in the end, these approaches only gave mixed results.

Modern in-office tooth whitening techniques have involved the use of high-strength hydrogen peroxide solutions in combination with heat lamps or curing lights. The results obtainable with these techniques are highly dependent upon the skill of the dental professional implementing the procedure. Moreover, constant attention to the client (patient) is required to obtain acceptable results. For instance, several commercially available high-intensity curing lights are available for “activating” tooth whiteners in an in-office setting. All of these lights require the dental professional to illuminate each separate tooth to be whitened individually over an extended period of time in order to achieve tooth whitening. Such operator-intensive techniques result in the high personnel costs associated with traditional in-office bleaching. The effectiveness of currently available tooth whitening techniques and compositions is also quite limited, often requiring extended use of valuable dental chair time and/or multiple visits to the dentist's office. These costs are passed on to the client (patient), resulting in an expensive and time-consuming service.

In the late 1980s the first dentist-prescribed “at-home” whitening system was introduced. See Haywood et al., Quintessence Int, 20, 173-176 (1989). This approach utilizes a fabricated “nightguard”/splint (a custom-made dental tray) and generally a carbamide or hydrogen peroxide “gel,” which the patient applies at home at their convenience. This approach has become the most popular type of tooth whitening today.

However, there are a number of problems with the dentist-prescribed at-home technique. The process takes a lot of patient time, taking anywhere from one to eight hours of “treatment” per day for a period of at least one to three weeks. The process also demands a certain degree of patient skill at dispensing the bleaching gel from its container (typically a syringe or tube) into the small tooth-sized reservoirs in the custom fitted tray. For example, when too much gel is placed in these, reservoirs, the excess material tends to “ooze” out of the tray and is then swallowed by the patient during the treatment period. Moreover, many of the gels used have an unpleasant taste and can cause throat irritation. Most patients with “average” discoloration have had reasonably good results, but patients with more difficult stains (e.g., due to antibiotics, trauma, etc) generally have not responded well under standard treatment time frames. Finally, many patients have found it too time-consuming or inconvenient to continue treatments, have not fulfilled their at-home obligations, and oftentimes become discouraged because they want faster or immediate results. Thus, for any given sample of patients beginning the take home process, the average result for these patients, when one takes into account the percentage of clients who are non compliant with the existing take home procedures, is poor.

Lack of client (patient) compliance with lengthy and inconvenient procedures, poor tasting tooth whitening products, and inconsistent results has resulted in an overall low level of patient satisfaction with the available take-home approaches to tooth whitening. The available in-office tooth whitening methods, by requiring multiple visits to or appointments with a dentist in order to achieve acceptable results, have been both time consuming to the client (patient) and have resulted in a waste of valuable resources such as dental personnel time and chair time. In fact, in order to conserve valuable in-office resources, dentists have passed on most of the tooth whitening procedure responsibility to their patients, finding it unprofitable to offer in-office tooth whitening.

There is a need for an in-office method/system which would provide consistently good results with all types of cases, which would conserve dental office resources by producing a high degree of tooth whitening in a short period of time, and which would not cause much tooth sensitivity or discomfort to the client (patient). Moreover, there is a need for a method/system which can provide results generally in one appointment without the burdens of using rubber dams or other extensive barrier materials. Finally, there is a need for a method/system which can obtain results within a short time frame, provide a tooth whitening service to a plurality of clients (patients) using a limited and economical number of dental professionals (dentists, hygienists, technicians, etc) within a single physical or geographic location and within the course of a day and can guarantee a high level of patient satisfaction.

### SUMMARY OF THE INVENTION

The present invention provides a method for tooth whitening capable of simultaneously whitening the teeth of more than one client (patient) at a time. In a preferred embodiment, this tooth whitening is done in a tooth whitening center which comprises a tooth whitening service module. A tooth whitening service module comprises two or more tooth whitening stations which can be operated by a single dental professional.

In a preferred embodiment, the method of the invention provides tooth whitening services to a plurality of clients by providing at least one dental professional and at least two tooth whitening stations for each dental professional and having each dental professional administering tooth whitening simultaneously to more than one client at a time.

Other embodiments of the invention employ tooth whitening service modules in dental practices run by a dental professional (associate centers) and in other image enhancement environments, such as hair and nail salons, spas, and plastic surgery centers. Associate centers implement the same method of the master tooth whitening centers at different locations, for example, individual dental practices, but typically have tooth whitening service modules comprising only a single dental professional. Satellite centers, or satellites, comprise a single tooth whitening station and a single dental professional, but derive benefits by being part of a regional network of one or more tooth whitening centers, associated centers, or combinations thereof.

In another embodiment of the invention, the tooth whitening modules and satellites of the invention can also be deployed in orthodontic practices. Clients in this embodiment of the invention are orthodontic patients as well as clients desiring whitening who find it convenient to have whitening services done at this location. The method of the inventions in this embodiment comprises tooth whitening service modules and satellites in the context of an orthodontic practice. Depending upon the size of the orthodontic practice either associate centers or satellite centers can be provided. Larger cosmetic orthodontic centers are also contemplated by the invention. Associate centers at an orthodontic practice can grow to be master tooth whitening centers to fulfill increased market demand.

The invention comprises a process wherein satellite centers can evolve into associate centers which can grow into master tooth whitening centers depending upon if the volume of clients is sufficiently large. A dynamic interplay between satellite centers, associate centers, and master tooth whitening centers, to form a network, meets the changing needs for whitening services in a geographical area.

Tooth whitening service modules can be distributed throughout a prescribed geographic area, as associate centers, in image enhancement environments and in tooth whitening centers to form a network of locations where tooth whitening is performed that benefit from coordinated advertising through local media. The whole network can be organized for marketing purposes.

In another embodiment of the invention, the invention is a method for whitening teeth for a plurality of clients (patients) covering a geographical area. This embodiment of the invention comprises one or more tooth whitening centers (master tooth whitening centers) and a plurality of associate centers to fulfil the tooth whitening needs in a particular regional area.

A regional network comprising a tooth whitening center geographically central to a plurality of associate centers and/or satellite centers, all of which provide a tooth whitening method that can provide substantially whitened teeth in less than two hours, is also included in the invention. Preferably all locations provide standardized procedures for tooth whitening and client processing.

The invention preferably comprises a maintenance program as part of the tooth whitening method. A maintenance program may comprise one or more oral care compositions, a dietary program, a “touch-up” treatment or program, a home-use tray administered tooth whitener, or any other means or method of maintaining the tooth whitening results achieved by a client of the method of the invention.

An advantage of the method of the invention is that it is fast, safe, and convenient, and does not involve uncomfortable dental trays, either in office or take home, and long term treatment.

Another advantage of the invention is that dental personnel within the tooth whitening service module are utilized in an efficient manner solely for the purpose of whitening the teeth of a plurality of clients (patients), reducing the costs associated with providing the service.

An advantage of the invention is that the tooth whitening service modules are wholly devoted to tooth whitening with infrastructure and personnel consecrated solely for the purposes of introducing the method and evaluating clients, optionally priming or preparing teeth for whitening, and whitening teeth. The module infrastructure preferably comprises two or more chairs dedicated to tooth whitening. This arrangement of module infrastructure and personnel provides efficiency and enables the economical and simultaneous treatment of a large number of clients (patients).

Another advantage is that the high level of patient satisfaction achieved in the tooth whitening by the invention provides an environment within which the client (patient) is psychologically predisposed to purchasing additional image enhancement products that may be sold in the centers or elsewhere.

Another advantage of the invention is that it provides standardized methods for providing tooth whitening over large geographical areas in a way that is sensitive to the population and market needs throughout the area.

### DETAILED DESCRIPTION OF THE INVENTION

The present invention provides, in one embodiment, a method of simultaneously providing tooth whitening services to a plurality of clients at a tooth whitening center. Tooth whitening centers of the invention have a tooth whitening service module. A tooth whitening service module comprises at least one dental professional trained to administer a tooth whitening method and at least two tooth whitening stations. The simplest embodiment of a tooth whitening service module comprises one dental professional trained to administer a tooth whitening method and at least two tooth whitening stations. The tooth whitening service modules of the invention are designed to provide for the simultaneous treatment of a two or more clients (patients) by a single dental professional.

It would not have been expected that the process of tooth whitening would be amenable to treating many clients (patients) in an efficient fashion. However, the method of the invention provides efficiency, by providing an organizing infrastructure enabling the efficient whitening of the teeth of more than one client at a time by a single dental professional. This economy of personnel provided by the invention enables whitening the teeth of many clients during the course of a business day, thereby providing tooth whitening services to far more clients than can be achieved through traditional dental practices. This provides for greater profitability, making tooth whitening a business more dental professionals will want to participate in and thus tooth whitening services can be provided to many more customers than before the invention. The tooth whitening service module, the whitening methods used therein, and the infrastructure provided by the tooth whitening centers achieve an improvement of shade changes per unit time for a population of clients that could never have been achieved before the invention.

The invention provides tooth whitening services to a plurality of clients at the same time in a single embodiment of the invention by administering tooth whitening simultaneously to more than one client at a time. Administering tooth whitening simultaneously to more than one client at a time means the contemporaneous administration of a tooth whitening method to two or more clients. Administering tooth whitening simultaneously can mean that two or more clients begin the tooth whitening method at the same time or about the same time. Administering tooth whitening simultaneously can also mean that two or more clients undergo a tooth whitening method at the same time, but begin the method at different times. Client can also end undoing the method at different times.

In addition to tooth whitening centers, other embodiments of the invention comprise the simultaneous whitening of the teeth of more than one client at a time by providing the tooth whitening service modules of the invention in other contexts such as cruise ships, military and governmental facilities, destination resorts, malls, spas, and health and exercise clubs. In a preferred embodiment of the invention, a tooth whitening service modules are located in conventional dental offices that performs other dental procedures which. An associate center is defined herein as a conventional dental office, or a cruise ship, or a military facility, or a governmental facility, or a destination resort, or a mall, or a spas, or a health and exercise club, or any other such location in which tooth whitening services are performed which also comprises a tooth whitening service module. A preferred associate center is a conventional dental office comprising a tooth whitening service module with one dental professional. Satellite centers are conventional dental offices that utilize a single whitening station for administering a tooth whitening procedure, but are regionally affiliated with at least one other tooth whitening center or associate center through a common network of advertising and promotional activities.

Tooth whitening stations are locations consecrated for tooth whitening. A tooth whitening station in its simplest form comprises a positioning means in which clients can be positioned to have their teeth whitened. The positioning means is preferably a chair, and more preferably a dental chair. Other positioning means that can be used in the tooth whitening stations of the invention include lounges, couches, beds, tables, message tables, and the like.

Clients in this specification are individuals who are either potentially going to have their teeth whitened by the method of the invention (e.g., they have come in for information or they are being evaluated to determine whether they are suitable for the method based on an oral health record and/or oral examination) or are undergoing the method of the invention. Clients are also referred to as patients, subjects, or individuals. These terms are to be thought of as interchangeable in the context of the invention and in this specification. The singular “client,” or “the client” is often used throughout this specification to describe how an individual client undergoes the method of the invention. This should not be taken to imply that only one client at a time undergoes the method of the invention.

Walk-in clients are clients who come without an appointment to a tooth whitening center.

Dental personnel can be a dentist or other qualified dental professional, such as a registered dental hygienist or registered dental assistant. The terms dental personnel and dental professional will generally be used to refer to all of these individuals unless specified otherwise.

The tooth whitening method may comprise any number of discrete steps or procedures, including, but not limited to, a written, oral or audiovisual consultation describing the method, an oral examination, a pre-whitening preparation (priming the client's teeth), a tooth whitening procedure or process, a post-whitening treatment, one or more intramethod or intraprocedure brand imprinting events, a written, oral, or audiovisual post-whitening consultation, an exit interview, and a follow up interview. As a result of the organization of personnel and resources, clients (patients) are efficiently and economically “processed” through tooth whitening service modules.

The tooth whitening service module provides a physical setting and/or context for performing a tooth whitening process or method whereby individuals can efficiently have their teeth substantially whitened in less than about 120 minutes, more preferably in less than about 90 minutes, and most preferably in less than about 60 minutes. Any tooth whitening method can be used in the tooth whitening module provided that substantial whitening of each client's teeth is achieved in less than about 120 minutes. The tooth whitening method does not include preliminary and preparatory activities such as dental examinations, pre-whitening tooth priming, and placement of gingival isolation materials. Moreover, the tooth whitening method does not include follow-up activities such as clean-up, consultation, and other post-tooth whitening process activities. The tooth whitening method, as used in this specification, includes only those activities, procedures, or processes related to the actual whitening of the client's teeth. Any tooth whitening method can be used in the tooth whitening module provided that for a plurality of clients, substantial whitening is achieved through the administration of a tooth whitening method for a duration of less than about 120 minutes.

In the invention individual dental personnel work with a number of clients at the same time, simultaneously whitening their teeth.

In a preferred embodiment of the invention all of an individual client's cosmetically visible teeth (those teeth that are visible to other people when the client smiles) are whitened simultaneously. A preferred embodiment of the invention whitens all of a client's cosmetically visible teeth simultaneously by using a device that provides light simultaneously to all of a client's cosmetically visible teeth at the same time in a light enhanced tooth whitening method.

Substantial whitening of a client's teeth is herein defined as at least a 50% of maximum attainable improvement in tooth color whiteness or brightness as measured with a standard dental tooth shade guide shortly after, and preferably within about an hour, of treatment. A shade guide is a pictorial chart of various shaded teeth. A preferred shaded guide is the VITA® Lumin® Vacuum shade guide (VITA Zahnfabrik, H. Rauter GmbH & Co. KG, Bad Säckingen, Germany). The range of tooth shades in the VITAE Shade Guide, the VITAPAN® system, varies from very light (B1) to very dark (C4). A total of 16 tooth shades constitute the entire range of colors between these two endpoints on a scale of brightness. The 16 tabs of the VITA® Shade Guide are arranged according to degree of brightness in the designations B1, A1, B2, D2, A2, C1, C2, D4, A3, D3, B3, A3.5, B4, C3, A4, and C4. For example, the maximum attainable improvement in brightness for a client, using this guide, beginning with a shade of C4 is 16 shades and the maximum attainable improvement from a starting shade of A3 is 8 shades. An improvement refers to changes of shade from a darker to a lighter shade.

For example, a client with a starting tooth color of C4 on the VITA shade guide has a maximum potential improvement of 16 shades. Such a client would be substantially whitened if a change of 8 shades of improvement (8/16=50%) or more is observed. A client with a starting tooth color of A3 on the VITA shade guide has a maximum potential improvement of 8 shades, therefore a change of 4 shades of improvement or more would satisfy the substantial whitening criterion. By providing substantially whitened teeth within a relatively short period of time, the method of the invention generates a high degree of client satisfaction and fulfills a long felt need in the art for rapid high quality tooth whitening.

It is to be understood that some clients may present intractable tooth stains that resist removal, while others may be more easily whitened. A range of whitening results is therefore observed. In a statistical treatment of large numbers of whitening results, clients who have been substantially whitened (>50% of maximum potential whitening on the VITA® shade guide scale) by the method of the invention represent a minimum of two-thirds (66.7%) of the general population. For the purpose of statistical confidence, the general population can be assumed to be represented by sample groups of about 1000 patients or larger. Thus, substantial whitening of two out of every three patients in the general population is achieved by the method of the invention.

Since it is difficult for a trained observer to objectively distinguish half shade differences in tooth color, substantial whitening is determined by calculating the nearest whole shade change number after rounding up. For example, if the maximum potential shade change improvement is 13 shades and the calculated shade change requirement for substantial whitening is 6.5 shades, the actual required shade change for substantial whitening would be 7 shades (6.5 rounded up to the nearest whole number).

The following Table I summarizes the minimum shades changes, rounded up to the nearest whole number, required for substantial whitening for teeth having different starting shades:

TABLE I
Minimum shade change requirements for substantial whitening.

| | | Minimum Shade Changes |
|---|---|---|
| | Maximum Potential Shade | Required for Substantial |
| Starting Shade | Change Improvement | Whitening |
| C4 | 16 | 8 |
| A4 | 15 | 8 |
| C3 | 14 | 7 |
| B4 | 13 | 7 |
| A3.5 | 12 | 6 |
| B3 | 11 | 6 |
| D3 | 10 | 5 |
| A3 | 9 | 5 |
| D4 | 8 | 4 |
| C2 | 7 | 4 |
| C1 | 6 | 3 |
| A2 | 5 | 3 |
| D2 | 4 | 2 |
| B2 | 3 | 2 |
| A1 | 2 | 1 |
| B1 | 1 | 1 |

Efficiency Achieved by the Method of the Invention

A whitening productivity “coefficient” can be used to describe the efficiency of the module in terms of its use of resources (personnel and whitening stations) relative to its tooth color improvement output (shade changes per day).

The Whitening productivity coefficient can be defined according to the following equation.

Whitening Productivity Coefficient (WPC)=(ASC)(WS)(480 min/day)/(DP)(PT) where;
ASC=Average shade change for a particular tooth whitening method
WS=Number of whitening stations
DP=Number of dental professionals
PT=Tooth whitening procedure time in minutes

The Whitening Productivity Coefficient (WPC) numerically represents the ability of a tooth whitening service facility (such as a conventional dental office, a tooth whitening service module, a tooth whitening center, an associate center, or a satellite center) to provide tooth shade improvement in clients during the course of an 8 hour (480 minute) day. In addition, the coefficient can also be calculated in such a way as to represent the shade improvement potential of the facility in terms of shades per week, or some other period of time.

The minimum acceptable parameters for the inventive tooth whitening service module are attained when the ASC=4, the WS=2, the DP=1, and the PT=120 minutes. This would result in a whitening productivity coefficient of 32, which would represent the minimum whitening productivity coefficient for any given tooth whitening service module. As another example, when ASC=6, WS=6, DP=3, and PT=60 minutes, the whitening productivity coefficient is 96.

The shade changes achievable by a single tooth whitening service module depends upon the number of tooth whitening stations per dental professional, as well as the duration and effectiveness of the tooth whitening method used. Tables II-IV illustrate ranges of shade change for different ratios of whitening stations (WS) to dental professionals (DP), the duration of whitening procedure, and the average shade change (effectiveness) observed. The number of shades possible for an 8 hour day assume full occupancy of tooth whitening stations for the entire day and no down time for the dental professional. The results illustrated in the Tables also demonstrate the improvement in module shade change capability with increases in the average shade change.

TABLE II
One Dental Professional + Two Whitening Stations
DP = 1; WS = 2

| Procedure Time | | |
|---|---|---|
| (min) | Average Shade Change | No Shades/8 hr Day (WPC) |
| 120 | 4 | 32 |
| 90 | | 43 |
| 60 | | 64 |
| 30 | | 128 |
| 120 | 5 | 40 |
| 90 | | 53 |
| 60 | | 80 |
| 30 | | 160 |
| 120 | 6 | 48 |
| 90 | | 64 |
| 60 | | 96 |
| 30 | | 192 |
| 120 | 7 | 56 |
| 90 | | 75 |
| 60 | | 112 |
| 30 | | 224 |
| 120 | 8 | 64 |
| 90 | | 85 |
| 60 | | 128 |
| 30 | | 256 |
| 120 | 9 | 72 |
| 90 | | 96 |
| 60 | | 144 |
| 30 | | 288 |
| 120 | 10 | 80 |
| 90 | | 107 |
| 60 | | 160 |
| 30 | | 320 |

TABLE III
One Dental Professional + Four Whitening Stations
DP = 1; WS = 4

| Procedure Time | | |
|---|---|---|
| (min) | Average Shade Change | No Shades/8 hr Day (WPC) |
| 120 | 4 | 64 |
| 90 | | 86 |
| 60 | | 128 |
| 30 | | 256 |
| 120 | 5 | 80 |
| 90 | | 106 |
| 60 | | 160 |
| 30 | | 320 |
| 120 | 6 | 96 |
| 90 | | 128 |
| 60 | | 192 |
| 30 | | 384 |
| 120 | 7 | 112 |
| 90 | | 150 |
| 60 | | 224 |
| 30 | | 448 |
| 120 | 8 | 128 |
| 90 | | 170 |
| 60 | | 256 |
| 30 | | 512 |
| 120 | 9 | 144 |
| 90 | | 192 |
| 60 | | 288 |
| 30 | | 576 |
| 120 | 10 | 160 |
| 90 | | 214 |
| 60 | | 320 |
| 30 | | 640 |

TABLE IV
One Dental Professional + Six Whitening Stations
DP = 1; WS = 6

| Procedure Time | | |
|---|---|---|
| (min) | Average Shade Change | No Shades/8 hr Day (WPC) |
| 120 | 4 | 96 |
| 90 | | 128 |
| 60 | | 192 |
| 30 | | 384 |
| 120 | 5 | 120 |
| 90 | | 160 |
| 60 | | 240 |
| 30 | | 480 |
| 120 | 6 | 144 |
| 90 | | 192 |
| 60 | | 288 |
| 30 | | 576 |
| 120 | 7 | 168 |
| 90 | | 224 |
| 60 | | 336 |
| 30 | | 672 |
| 120 | 8 | 192 |
| 90 | | 256 |
| 60 | | 384 |
| 30 | | 768 |
| 120 | 9 | 216 |
| 90 | | 288 |
| 60 | | 432 |
| 30 | | 864 |
| 120 | 10 | 240 |
| 90 | | 320 |
| 60 | | 480 |
| 30 | | 960 |

As seen in the above Tables, the number of shade changes attainable per day can be described as a whitening productivity coefficient. Because of the efficiencies introduced by having the dental practitioner whitening the teeth of a plurality of clients simultaneously, the tooth whitening service module of the invention achieves a high whitening productivity coefficient in shades per unit time.

In a preferred embodiment of the invention, tooth whitening service modules are situated in tooth whitening centers which comprises areas for specialized purposes, such as, reception areas, medical and oral review areas, and tooth priming stations. Tooth whitening service module, in this embodiment of the invention, can comprise tooth priming stations. Preferably, all of these discrete areas for specialized purposes occupy physically distinct regions within the tooth whitening center. The medical and oral review may take place at the tooth whitening station within a tooth whitening service module.

The reception area of a tooth whitening center of the invention comprises a reception desk, with computers and telephones, and preferably also comprises stations (points or areas) at which clients can sit and read informational materials about the tooth whitening center and method of whitening teeth at the center. The informational materials may also be available in the form of audiovisual presentations, which include computer programs, videos and repeating or interactive television broadcasts. Preferably the stations where the patient can read, review or interact with informational materials about the tooth whitening center and method are desks or carrels. These stations can also be referred to as informational stations. The design of the reception area is such that clients coming in without an appointment can obtain information about the method of the invention, review this information, determine for themselves whether they would like to pursue treatment (tooth whitening) at the center, and pay for the treatment and post treatment options.

Tooth priming stations, which can be included within a tooth whitening service module, comprise at least one sink and preferably provide toothbrushes and pre-whitening dentifrice. Preferably tooth priming stations further comprise a counter. In an even more preferred embodiment trays are provided on a counter adjacent to the sink at the tooth brushing station. These trays comprise pre-whitening toothpaste, a toothbrush, tissues, and mouthwash.

Tooth whitening stations have already been described and generally comprise means of comfortably positioning the client for a tooth whitening procedure. In one embodiment of the invention, the chairs are separated from each other by barriers or walls. In a preferred embodiment the tooth whitening stations have entertainment such as televisions, radios or computers which the clients can watch during the whitening treatment. Preferably earphones are also provided.

In one embodiment, the tooth whitening centers of the invention have a sterilization center to disinfect or sterilize dental tools and equipment to be used in the tooth whitening procedure. The sterilization center may include an autoclave and an ultrasonic cleaner to clean and sterilize such tools and equipment used in the tooth whitening procedure. For example, tools used in the tooth whitening procedure are placed in the ultrasonic cleaner (BioSonic UC 100 from Whaledent) followed by sterilizing disinfection.

The tooth whitening centers of the invention preferably have a scrub station where dental practitioners and other practitioners can maintain good hygiene. Preferably the scrub station is located out of sight of the tooth whitening stations so that maintaining good hygiene is efficient without disturbing the clients in the tooth whitening station.

The medical dental/evaluation of clients (patients) can be done in the chair in which tooth whitening is done, however, a preferred embodiment the tooth whitening center (facility) has one or more examination chairs where clients can be screened to determine whether they are suitable for treatment.

Having clients move through discrete areas at a tooth whitening center provides for increased efficiency of the method of the invention. The discrete areas at the tooth whitening centers may include a reception area with multiple informational stations (or points), where clients (patients) that are provided with materials containing information about the method of whitening teeth at the center can examine and read these materials, one or more tooth priming stations, where clients (patients) brush their teeth or have their teeth brushed with a dentifrice which prepares the teeth for whitening, and a plurality of tooth whitening stations set up for whitening the teeth of clients. This embodiment of the invention provides an arrangement that enables an efficient flow of a plurality of clients through the tooth whitening service module.

When the efficient flow of clients is combined with the tooth whitening methods described herein, the method of the invention provides for tooth whitening that is both efficient and high quality, as well as economical in its use of personnel and resources. This combination of efficiency and high quality tooth whitening provided by the method of the invention achieves a far higher number of overall shades of tooth whitening improvement per unit time than by other methods. Instead of a linear, one-client-at-a-time method of whitening teeth, several clients may have their teeth whitened simultaneously by a single dental professional, thus providing a high throughput service. The method of the invention accomplishes this by simultaneously whitening the teeth of a plurality of clients in a short period of time (preferably in less than about two hours from the time they start treatment) with a tooth whitening procedure capable of substantially whitening a client's teeth.

Preferably prospective clients who have not already made an appointment (walk-in clients) review the method of the invention in a reception area to determine if they desire having tooth whitening services performed. The client reviews this information and if the client is interested, and has a suitable oral health record, the client is given a medical/dental screening to determine his or her suitability for the tooth whitening procedure. Clients who come in with an appointment preferably are pre-screened by a non-module dental professional or can just have their oral health records checked. If the client elects to undergo tooth whitening, in a preferred embodiment of the invention, a brief oral examination is given by a dental professional, before whitening the client's teeth, to evaluate whether the client is suitable for tooth whitening. If the client is found to have suitable oral health, the client's teeth are then whitened at a tooth whitening station within a tooth whitening service module. If a client is not accepted as a candidate for tooth whitening in a tooth whitening service module (for reasons such as tooth decay, periodontal disease, gingival recession, or other oral health diagnoses), the dental professional in the module preferably refers that client to a dental practitioner to fix the problem. Once treated off-site, clients who still wish to obtain tooth whitening services may question the practitioner about available options and procedures. Although the practitioner may offer tooth whitening services, the personnel/resource versus cost issue of in-office whitening, together with the results obtainable with prior art methods and compositions, results in the client returning to the tooth whitening service module for treatment. Dental practitioners who do not attempt to retain such potential clients for whitening services, but rather freely allow them to return to the tooth whitening service modules (which are capable of providing a superior result and service), will obtain more referrals from the service modules, and so forth. A cooperative business arrangement is thus established between the tooth whitening service modules and the general dental practitioner that profits both entities. Dental practitioners who refer clients to the tooth whitening service modules of the invention, but do not actively whiten clients' teeth, may still be considered part of a tooth whitening service network. Such practitioners may advertise, for instance, the availability of tooth whitening services at a tooth whitening center, associate center, or satellite center.

Preferably all persons, whether they have an appointment or not are given an oral examination to determine if they are suitable for tooth whitening. This will help clients or potential clients determine whether they are interested in having their teeth whitened by the method of the invention. Preferably receptionists and consult managers handle initial client inquiries and provide information and support for the client to make a decision.

Preferably, clients interested in having their teeth whitened by the procedure of the invention are evaluated to determine whether they are suitable for tooth whitening by reviewing and/or preparing the client's medical and/or dental history and preferably giving clients an oral dental/medical examination to assure that their teeth are sufficiently healthy to undergo tooth whitening.

The oral screening can be done at a tooth whitening station in the tooth whitening service modules. In a preferred embodiment of the invention, the medical/dental screening is done with the client in an examination (screening) chair, outside of the tooth whitening service modules and away from the chairs used for tooth whitening in order to determine how tooth whitening chairs will be filled. Preferably the screening in the examination chair takes less than about ten minutes and more preferably less than about 5 minutes. Clients who qualify for treatment can be given places in tooth whitening stations as they become available. Alternatively, the screening examination may be performed in a tooth whitening chair (when available). Where whitening stations are available, because they are not occupied by a client undergoing a tooth whitening procedure, using whitening stations for examination will not reduce the efficiency of the method and detract from the high throughput capacity of the center. The method of the invention can thereby handle a diverse population of clients, some of which have appointments and some that do not. Where there are a large number of clients being provided with the tooth whitening service of the invention, some combination of examining clients in examining chairs and in whitening stations may be optimal. Examination chairs are particularly useful in screening potential clients who have come in without an appointment. This adds to the efficiency of the method because chairs designated for whitening need not be filled with clients who are not eligible to undergo the procedure of the invention. In a preferred embodiment of the invention, the examination chair is used to screen clients who come without an appointment. In this way the flow of scheduled clients is maintained, while new potential clients are screened and processed through the tooth whitening procedure of the invention as whitening chairs become available. The use of examination (screening) chairs in this way provides added efficiency for the method since potential clients can be quickly qualified or disqualified for the procedure without tying up whitening chairs. If the client's oral health is acceptable (absence of obvious tooth decay, periodontal disease, exposed root surfaces, etc), the client can then proceed with tooth whitening. If there are health and/or dental problems, such clients are referred back to their dentist or to an outside general dental practitioner designated by the tooth whitening module personnel. In this embodiment of the invention, for each screening chair, a plurality of chairs can be dedicated to tooth whitening, since screening is much quicker than tooth whitening. A dental professional can be stationed at an examination chair, servicing clients as they come in. For example, there may be from six to twenty chairs dedicated to whitening for every examination chair.

Where the screening chairs are the same as those used in the tooth whitening stations, a maximum of about six screening-whitening chairs can be used per dental professional within the module. Thus, as the number of whitening chairs increases beyond six, it is preferable to separate the screening and whitening functions into physical distinct areas or locations and use an examination (screening) chair. Additional dental professionals may be required to operate the tooth whitening service module with has a greater number of whitening chairs. However, the efficiencies and economies of scale introduced by the invention are still maintained because the dental professional (DP) to whitening station (WS) ratio of 1 to at least 2 (0.50) is met. In an embodiment of the invention which includes an examination chair, a high throughput tooth whitening service module can comprise, for example, three dental professionals and twelve whitening stations, which would have a DP to WS ratio of 3 to 12 (0.25). The inventive tooth whitening service module preferably has a DP to WS ratio less than or equal to 0.50.

Preferably, evaluating the client further comprises consulting with the client regarding the method of tooth whitening at the center which includes discussing possible results, limitations, potential risks, and contraindications, preparing a health history, and obtaining informed consent from the client for the client's undergoing the method of the invention. Preferably, the consultation is under the supervision of a dentist. The client fills out documents or forms at the stations (or points) in the reception area. The stations in the reception area can be desks or tables set up for enabling the client to obtain information about the tooth whitening method at the center. Preferably the client is informed at this stage regarding any potential discomfort and that pain medication can be taken if needed.

Preferably the client is also informed about how long the procedure lasts after treatment and provided with post whitening instructions to protect the client's teeth from restaining. The post whitening instructions may include the use of maintenance products that are sold within or upon exiting the tooth whitening service module.

Preferably photographs of clients' teeth are taken before and after they undergo the method of the invention (treatment), so that comparisons can be made. Preferably the photographs develop rapidly so that a client can examine before and after photographs during the visit. For example, preferred photographs are Polaroid™. Alternatively, digital still or video cameras may be used to acquire image data that may be processed or analyzed in such a way as to yield useful information about a client's before and after tooth shade. Digital imaging can also provide an efficient means of archiving patient result data for future use, for instance as a tool for gathering large amounts of whitening result data from multiple tooth whitening centers for statistical analysis. Digital imaging of clients' teeth and subsequent processing with image analysis software may also provide a more objective tool for evaluating before and after tooth shades. Image analysis of tooth color may be done manually or automatically at the tooth whitening center or at a separate image processing location with real-time communication links with multiple tooth whitening centers.

Preferably, evaluating the client further comprises comparing the shade of a client's teeth to shades in a shade guide and choosing a desired shade as a goal of treatment. Records are kept of the client's teeth shade before undergoing the procedure. After treatment by the method of the invention, clients can compare the shade of their teeth to the chosen shade and determine whether the desired shade has been achieved. Preferably reasonable goals are set for the client in consultation with the dental personnel at the tooth whitening center.

Preferably clients examine their teeth in a mirror with a dental practitioner and pick a shade that represents the shade of their teeth in the shade guide. They then choose a shade from the shade guide in consultation with the dental practitioner as a goal. Preferably, teeth are whitened to the upper shades (i.e. B1, A1, B2, D2). For example, a client entering the tooth whitening process with a B4 shade will preferably be whitened to a post treatment shade in the range of about B1 to A2.

In another preferred embodiment, image data can be acquired through digital photography or video capture and shades can be compared using color analysis with appropriate software, instead of the “manual” procedures described above.

Preferably, before undergoing the tooth whitening procedure, all lipstick and makeup are removed from the mouth area of clients. Preferably, the tooth whitening procedure begins after a client has been approved for tooth whitening.

To prepare the teeth to be efficiently bleached, the client's teeth are preferably primed by removing all or part of the acquired pellicle from the surface of the teeth to be whitened. The acquired pellicle is a protein film that accumulates on all exposed tooth enamel surfaces. Preferably an abrasive material, i.e., a prophy paste or pre-whitening toothpaste, is used to remove plaque and surface stains attached to the acquired pellicle. Priming the teeth preferably comprises brushing them at a tooth brushing station. The tooth brushing station has at least one sink and preferably provides toothbrushes, dentifrice, and mouthwash.

In general, priming the teeth for tooth whitening comprises removing some or all of the acquired pellicle from the surface of the enamel of the teeth to be whitened. Priming the client's teeth in the tooth whitening centers of the invention preferably comprises brushing the client's teeth with a dentifrice. This brushing preferably is done at a tooth priming station. The dentifrice can be, for example, a toothpaste designed to remove excess plaque or acquired pellicle.

Other preferred methods of priming the client's teeth include, for example, removing the acquired pellicle by mechanical abrasion, such as with an abrasive dentifrice, or chemical means. Mildly acidic solutions that do not harm the enamel yet solubilize the pellicle protein can also be used to facilitate acquired pellicle removal. Preferably, a combination of both mechanical and chemical means is employed by using a pre-whitening toothpaste. A preferred dentifrice comprises an abrasive, such as hydrated silica, hydrated alumina, or anhydrous dicalcium phosphate. A particularly preferred pre-whitening toothpaste comprises a hydrated silica abrasive, is adjusted to a pH of about 5.0 with citric acid, and can also comprise other inactive ingredients such as thickeners, humectants, water, detergents, flavorants, and preservatives. A most preferred dentifrice is BriteSmile Prewhitening toothpaste. Optionally, supragingival polishing of teeth can be done by a dental professional. Preferably clients brush their own teeth. The priming of the client's teeth removes plaque and acquired pellicle.

In a preferred embodiment, whitening a client's teeth at a tooth whitening station generally comprises first isolating (protecting) the gingival tissue and thereafter applying a whitening composition to the surface of the teeth to be whitened. Optionally, an appropriate light for activating or accelerating the whitening composition can be positioned opposite to the client's teeth for a period of time. Preferably the application bf tooth whitening composition and positioning of the optional light is repeated two more times for a total of three cycles of applying whitening composition and light for a period of time.

Preferably, before whitening, the client's gingival tissue is isolated from potential contact with the tooth whitening composition. A cheek retractor is gently placed in the client's mouth to keep the lips and gums away from contacting the surfaces of the teeth to be whitened. Gingival and mucosal isolation materials are then applied. Isolating the client's teeth preferably comprises the steps of placing on the client's lips a cheek retractor, then inserting a bite block or other suitable device (which may also serve as an alignment or spacing device to position the optional tooth whitening light) into the client's mouth and using a gingival isolation material to cover or seal the gums. A variety of isolation materials can be used. Preferred isolation materials are light-curable resins such as those described in International Publication No. WO 98/36700, which is herein incorporated by reference, or dental rubber dams molded to fit over the gums. A preferred light-cured isolation material is OpalDam™ (Ultradent Products, Inc., South Jordan, Utah). Preferably the gingival isolation material is syringed or painted on the client's gums in such a manner as to cover the margins between the upper third of enamel and the edge of the gum line and then curing with a curing light. Care must be taken to isolate the gingival tissue in such a way as to prevent the leakage of tooth whitening chemicals underneath the isolation material. A preferred curing light is the OptiLux 500 (Demetron Corp., Danbury, Conn.).

Preferably, a light-blocking cream is applied to exposed lip areas and other mucosal tissue in order to prevent exposure of tissue to actinic radiation from the light source (if any).

Preferably the light-blocking cream contains an inorganic pigment that absorbs the entirety of the spectral output of the light source. Preferred inorganic pigments are titanium dioxide and zinc oxide.

Once the isolation procedure has been completed, which typically takes between about 5 and about 15 minutes, the active whitening chemicals (gel) are applied onto the tooth surfaces to be whitened. Preferably the whitening gel is applied at about 1 to 2 mm thick on the surface of the client's teeth. Preferably the whitening gel is applied using a syringe.

The whitening gel can comprise from about 5% to about 35% hydrogen peroxide. Preferred whitening gels comprise from about 3% to about 20% hydrogen peroxide. More preferred gels comprise from about 6% to about 15% hydrogen peroxide. Most preferably, the whitening gel is BriteSmile 2000™ Tooth Whitening Gel™. Most preferred whitening gels are those described in U.S. application Ser. No. 09/234/038 filed Jan. 19, 1999, which is herein incorporated by reference.

Any tooth whitening method can be used in the method of the invention, so long as the effectiveness is sufficiently good to provide for substantial tooth whitening in less than about 120 minutes. Preferred tooth whitening procedures are capable of substantially whitening a client's teeth in less than 120 minutes, more preferred tooth whitening procedures are capable of substantially whitening a client's teeth in less than about 90 minutes, and most preferred tooth whitening procedures are capable of substantially whitening a client's teeth in less than about 60 minutes. Thus, any composition and/or procedure for whitening teeth can be used in the tooth whitening modules of the invention provided that substantial whitening of each client's teeth is achieved in less than about 120 minutes.

Trays containing all of the components necessary to perform a single tooth whitening procedure may be prepared in advance (pre-pack) or just prior to the procedure. Some or all of the procedure components may be disposable. In one embodiment, the tooth whitening procedure trays comprise the following components: sterilizer bag, fiber-optic positioner, pre-whitening toothbrush, pre whitening tooth paste, cheek retractor, oral napkin, syringe tips, examination/screening mirror, dental explorer, headrest cover, aspirator tip, client (patient) bib, saliva ejector, syringe tip cover, cotton rolls, gingival isolation material, mucosal isolation material (sunblock), and tooth whitening gel. The tooth whitening gel may be stored separately from the pre-pack components. Sterilized trays can be prepared in the sterilization center.

In a preferred embodiment of the invention, all of the components required for a single tooth whitening procedure are pre-packaged and sterilized prior to arrival at the module, eliminating the need for sterilization of components in the vicinity of or in the module itself. Preferably, all of the tray materials are disposable and the tray materials are disposed of after use. Preferably, the sterilization and packaging of tools and materials needed for the tooth whitening methods used at the centers and associate centers are prepared at locations dedicated to preparation of these sterilized tools and materials. This embodiment of the invention achieves greater client throughput since tooth whitening personnel and resources can focus on whitening teeth.

Tooth whitening compositions suitable for use in the tooth whitening center method of the invention include those that contain active ingredients capable of rendering tooth stain chromophores colorless or less staining and also those capable of solubilizing tooth stain chromophores in order to make them more susceptible to mechanical or chemical removal. Active ingredients suitable for this purpose include, for example, hydrogen peroxide (and any hydrogen peroxide precursor), carbamide peroxide, sodium percarbonate, calcium peroxide, sodium perborate, potassium persulfate, peracetic acid (and other peracids), and chlorine dioxide.

Preferably, a tooth whitening composition is employed concurrently with an activation means that increases the speed and efficacy of the composition. The activation means can include a light source, a heat source, or a composition separate and distinct from the tooth whitening composition which chemically enhances the speed and efficacy of the tooth whitening composition (an activating composition). Activating compositions may contain metal ions and their chelation complexes, and peracid precursors (materials capable of forming peracids in the presence of hydrogen peroxide, such as glyceryl triacetate).

Preferably, a bite block or other suitable device with a removable spacer bar serves as a positioning device that is inserted in the client's mouth to guide the light.

Preferably, during the procedure, the client bites on a fiber optic positioner (FOP) comprising a bite block or other suitable device and a removable plastic spacing bar. The spacing bar is removed for ease of application of the isolation material during isolation of the teeth. The FOP positions the client's mouth relative to the lamp and keeps the client at an appropriate distance from the lamp during whitening. Preferably the FOP spacing is inserted to guide the position of the light head when light is applied to the client's teeth during the whitening process. The FOP is both a safety device which guarantees that the light does not get too close to be unsafe and a positioning guide for properly aligning the light with the client's teeth. Preferably the client bites on the FOP to give them a comfortable rest stop and to maintain the teeth in a separated position. The FOP maintains the clients mouth in an open position such that the tooth whitening composition can be applied to the teeth and light can contact the teeth. Additionally, the FOP protects the client's tongue from contacting the whitening agent.

Before applying light to the teeth, the light source is positioned. In positioning the light source, the spacing bar of the fiber optic positioner (FOP) is preferably center to the dimple of the light aperture (as a general guide) and the seam of the arm should preferably align with the client's occlusal plane.

A preferred light source is a plasma arc lamp. The most preferred light sources are the BriteSmile 2000™ and BriteSmile 3000™ fight sources, plasma arc lamps. The BriteSmile 2000™ is an integrated light source and delivery system in which a fixed light delivery head delivers energy efficient light of selected wavelengths to the teeth. The fight from the lamp is conducted via a fiber optic cable to the delivery head that positions and distributes the light to obtain a maximum efficiency at the work site. The BriteSmile 2000™ light source comprises a lamp module, control panel, delivery system, and a support structure. The BriteSmile 3000™ light source has a mobile support structure and a key card system for its access.

The lamp module, of both the BriteSmile 2000™ and BriteSmile 3000™, comprise one or more metal halide lamps with integrated power supplies. In a preferred embodiment, the output is filtered to provide an efficient source of visible blue light in the 400-550 nm range. In a more preferred embodiment, light is filtered to be in the 400-505 nm range.

The control panel of the BriteSmile 2000™ and BriteSmile 3000™ comprise a membrane switch to activate and set parameters and an alphanumeric display with visual and audio indicators to communicate information to an operator. The delivery system comprises a flexible arm with an integrated optical fiber delivery system and a light delivery head which is permanently mounted to a support structure. The support structure provides the mounting structure for the lamp modules, control panel, and light delivery system. The support structure of the BriteSmile 2000™ also provides a self-contained water system and a site for hookups to centralized air and suction.

Preferred light sources are described in U.S. patent application Ser. No. 09/233,793 filed Jan. 19, 1999, and U.S. Provisional patent Application Ser. No. 60/158,499 which are herein incorporated by reference.

Preferably light is applied simultaneously to all of the client's cosmetically visible teeth. Cosmetically visible teeth are those teeth that can be seen by an outside observer when a client exhibits his or her largest smile. A client's cosmetically visible teeth are generally the front eight maxillary (upper) and the front eight mandibular (lower) teeth that are visible when the client smiles or speaks. Preferably light is applied simultaneously to all of the client's cosmetically visible teeth using a plasma arc lamp.

Light sources capable of emitting radiation in the wavelength range necessary to activate photosensitizer(s) or otherwise raise the energy state of tooth chromogens are preferred. For example, light sources capable of emitting radiation that is both biologically safe and effective are preferred. More preferred are sources which emit limited amounts of infrared light (700 nm and above). Even more preferred are light sources that emit radiation in the wavelength range from about 350 nanometers to about 700 nanometers. Most preferred are light sources that emit radiation in the wavelength ranges from about 400 and about 505 nanometers.

In a preferred embodiment of the invention, output uniformity of the light is about +/−10% over the area of the beam once transmitted through a glass or plastic fiber to the optical output. The optical output is preferably place in front of a patient's teeth. Although there are no limitations on the input and length dimensions of such a fiber, one of about 10 millimeters in diameter and 2 to 3 meters in length is preferred.

Light energy may be provided by a source which generates a continuous electromagnetic spectrum filtered to the preferred wavelengths with a variation of no more than about +/−10%, or by a source which generates an emission line spectrum, or a combination of both. Suitable lamps which emit radiation in the preferred range of wavelengths include linear flash lamps, tungsten halogen, metal halide, Xenon short arc, Mercury short arc, Mercury Xenon short arc, Argon plasma arc, and Argon short arc lamps, among others. The output of two Mejiro BMH 250 watt metal halide lamps filtered through dichroic filters to between about 400 and 505 nanometers can be used.

The light energy can also be provided by an array of light emitting diodes or laser diodes of suitable wavelength and sufficient power.

The power density of the light delivered to the teeth can be from about 25 to 200 mW/cm². Preferably the power density, or energy delivered to the teeth, is adjusted to a setting of between about 100 to about 160 mW/cm² for applying light to the teeth during the whitening procedure. Preferably wavelength emissions are set at between about 400 nm and about 505 nm.

Preferably light is applied for a duration of about 15 to 30 minutes. Preferably the light source automatically turns off after the duration of application.

In a preferred embodiment of the invention, once the whitening gel is applied, a light source is positioned in front of the client's teeth to accelerate the whitening process. Once the light source is positioned, the client is asked to rest comfortably for approximately 20 minutes while light is applied, at which point the whitening gel will be suctioned off the client's teeth and replaced for a second approximately 20 minutes light exposure period. The whitening cycle is preferably repeated a total of three times, for a total whitening procedure time of approximately 60 minutes (excluding isolation). During the whitening cycles, the dental professional is free to move to other whitening stations and perform the procedure on other clients. Dental professionals performing the procedure on more than one client at a time is one factor which provides for the efficiency of the invention in being able to simultaneously treat a plurality of clients.

At the end of the final 20 minute whitening cycle, the remaining whitening gel is suctioned from the teeth, and the isolation material, cheek retractor, and all other devices are removed from the client's mouth. At this point, the client is preferably asked to rinse or brush away any residual whitening gel that may be remaining on the teeth. Preferably an intraprocedure brand imprinting composition is used (see below).

A whitening cycle comprises applying whitening gel to the teeth and then illuminating the teeth with light having the appropriate power density and wavelength. After each whitening cycle, excess whitening gel is preferably removed before the next whitening cycle. Preferably the excess gel is removed by suction.

After the excess gel from the first cycle is removed, whitening gel is reapplied for a second cycle. Light is than applied as above for about 20 minutes. Preferably a third cycle of applying whitening gel and then light for about 20 minutes is done.

After three or more cycles of whitening are complete, water and suction are used to remove the whitening gel and sun screen, the isolation materials are removed and the shade of the client's teeth is checked to determined whether the teeth are sufficiently whitened.

If additional whitening is desired, the client can schedule an additional whitening treatment in about a week to about eight weeks.

After the whitening cycles, the isolation material, cotton rolls, FOP and other excess materials are removed from the client's mouth. The teeth are preferably flushed thoroughly and then the cheek retractor is removed. Clients can then rinse their mouths in a sink.

Preferably, after the tooth whitening procedure is completed, the clients teeth are treated with a desensitizing composition selected from the group including, but not limited to, a potassium nitrate gel and a fluoride gel. A preferred potassium nitrate gel comprises from about 3% to about 6% potassium nitrate, by weight, of the composition. A preferred fluoride gel comprises neutral sodium fluoride. The fluoride gel helps seal the teeth again blocking the porosity of the teeth following the treatment. This helps reduce sensitivity of the teeth in the short term, since it ordinarily takes from about two to three days for the protective organic acquired pellicle to recover.

Preferably, after treatment, conventional or digital photographs are taken and the shade of the client's teeth is determined using a shade guide or image analysis software. Preferably, the client is then offered the opportunity to see his or her whitened teeth and enhanced smile in a mirror, which may be hand held, or may be placed on a wall near a post-whitening rinse/brush station (which may be the same as a pre-whitening tooth priming station). The new tooth color is preferably then evaluated in accordance with the methods described above using a shade chart. The client is shown the whitening results and the dental practitioner discuss maintenance in the short term (24 hour) and long-term maintenance. Preferably short term maintenance comprises advising clients to avoid anything that stains teeth, e.g., colored foods, smoking and coffee. At this stage teeth are vulnerable to staining because the pellicle has been removed. Colored food or smoking could cause intense staining.

Preferably the client is provided with information regarding maintenance programs to preserve the whitening achieved by the tooth whitening method of the invention. Preferred maintenance programs include touch up treatments or a client-administered tray method. The tray method comprises preparing a custom tray and using it every three months for about one to eight hours per use on a given day for a treatment.

Maintenance treatments are preferably provided over a period of two years following tooth whitening by the method of the invention. Maintenance treatments are provided at a lower cost than the full procedure and comprise typically shorter treatments than the full procedure.

Preferably the maintenance treatments are carried out about every six to nine months. A fee can be paid after the full procedure to obtain discount maintenance treatments.

After being informed about maintenance, the client, if the client has not pre-paid, can then pay at the front desk and is preferably reminded to stay away from foods that stain and to refrain from smoking. Preferably the client is given before and after pictures. Clients with and without an appointment can either pre-pay or pay at the end of the procedure.

Intraprocedure Brand Imprinting

The invention provides for the dissemination of information, such as information about the tooth whitening service. The tooth whitening modules provide an environment conducive to purchasing other goods and services associated with image enhancement. Products that can be marketed this way include, for example, toothpaste, mouthwash, dental floss, hair care products, facial creams, nail products, cook books which include recipes that are less tooth staining and other image enhancing products. Services that can be marketed in this way include cosmetic dentistry (other than tooth whitening), cosmetic surgery, and other image enhancement services.

In another embodiment of the invention, the invention provides a method of brand imprinting in the context of a tooth whitening center. The tooth whitening procedure used in the module may involve certain discrete steps that allow for the direct interaction of the client with a composition or device. Direct interaction is defined as a visual, tactile, audio, or gustatory contact with one or more compositions and/or devices used during the tooth whitening procedure. This direct interaction may be structured in such a way as to lead to post-whitening product or service sales ancillary to the actual tooth whitening procedure. Intraprocedure brand imprinting can be used during the client's interaction with, for instance, a pre-whitening toothpaste, a pre-whitening toothbrush, and a post-whitening mouthrinse.

In general, intraprocedure brand imprinting comprises the steps of administering an image enhancement procedure (such as tooth whitening) in an image enhancement facility (such as a tooth whitening center) to a client, exposing the client during the image enhancement procedure to a first composition, device or product that can be easily identified and remembered by the client when the procedure is finished, and then exposing same the client to a purchase opportunity. The purchase opportunity comprising at least one second composition, device or product that is reminiscent or redolent of the first composition, device or product that the client was exposed to during the image enhancement procedure. Finally, the client is given the opportunity to purchase the second composition, device or product prior to exiting the image enhancement facility. The first composition, device or product may be the same or may be different than the second composition, device or product.

Intraprocedure brand imprinting is achieved by having readily identifiable brand logos or seals attached to the outer packages of products such as the pre-whitening composition such that they suggest to the client that the tooth whitening center may have other branded packaged goods for sale. For example, when a tooth whitening method calls for the client to brush his or her teeth with a pre-whitening toothpaste, both the toothbrush and the tube of toothpaste should bear a logo, symbol, or design to indicate or suggest the availability of such products (and possibly others) for purchase.

In a preferred embodiment of the invention, the organoleptic properties (taste; texture, aroma, etc.) of the pre-whitening composition, for example, are pleasing and memorable to the client, in order to psychologically imprint the notion of quality and pleasing experiences during and after the use of the composition. This method of suggestive product placement within the context of the tooth whitening center procedure for whitening teeth will hereinafter be referred to as intraprocedure brand imprinting. Intraprocedure brand imprinting can be used throughout the procedure with any composition or procedure-related object or device with which the client may come into visual, audio, or olfactory contact. The properties (taste, mouthfeel, aroma, appearance, etc.) of such items with which the client has contact with during the tooth whitening method should be pleasing, so that they provide a positive impression of the quality of the brand. For example mouthwashes, tooth whitening compositions, and isolation materials could be used in this way. Intraprocedure brand imprinting serves to facilitate the sale of other products that can be sold at, for example the tooth whitening centers. Intraprocedure brand imprinting in the context of tooth whitening is a preferred embodiment of the invention. Intraprocedure brand imprinting can be used at any step of the method of the invention. For example, clients, in this embodiment of the invention, in order to prime their teeth for tooth whitening are asked to brush their teeth with a pre-whitening toothpaste which comprises a brand-imprinting composition, together with a brand-imprinting toothbrush, before undergoing tooth whitening.

While pleasing and memorable organoleptic properties may change over time with trends in cosmetics, fashion, cosmetic dentistry and other image enhancement industries, the specific properties of a brand imprinting composition may be determined though the use of focus groups, test marketing, polling, and other means of gathering public opinion about preferences in flavor, fragrance, texture, mouthfeel, and appearance. For example, a brand imprinting mouth-rinse packaged in an attractive container is used immediately after the tooth whitening procedure and offers a combined fresh and clean mouthfeel (astringence) with a flavor containing menthol and vanilla notes that are psychologically reenforcing of the color white (associating this with the tooth whitening procedure). This imprint is carried with the client into a purchase opportunity (for instance, a product display area in the exit lobby) with the expectation that the client will purchase other products that are consistent with the original favorable imprint.

Another means of brand imprinting during the tooth whitening procedure is through the use of fragrances that are redolent of and reinforcing of other flavored products with which the client has had or will have contact during the procedure. For example, the flavor and/or fragrance of the gingival isolation material (which will emanate an aroma throughout the tooth whitening procedure) can be the same or similar to that employed in the pre-whitening toothpaste. When clients enjoy the taste of the products used in the whitening procedures and are satisfied with the whitening of their teeth, they will associate the products sold at the centers with this excellent experience. They will then be predisposed to purchase products sold through the module or center, such as mouthwash, toothpaste, floss, toothbrushes and other image enhancement products and services. In one embodiment of the invention, the products used in the procedure will have the same taste, smell and look of products sold through the center for different purposes. For example, a pre-whitening primer used at the center having the same flavor and smell as ordinary toothpaste sold at the center will cause clients to purchase the toothpaste.

In a preferred embodiment of the invention, clients brush or treat their own teeth in the pre-whitening or priming stage with a toothpaste or other means that is packaged in such a way as to closely associate the tooth whitening center brand (for example, the brand made and/or sold under the name of the tooth whitening center) with the pre-whitening or priming composition and rinse their mouths immediately following the tooth whitening procedure with an intraprocedure brand imprinting mouthwash composition. Such a composition preferably provides the client's mouth with a fresh and clean taste after use, in order to positively reinforce the visual impact of the tooth whitening procedure results (i.e., whiter teeth). The whiter teeth may also reinforce the client's perception of the quality of the procedure, thereby leading to a potential “after-market” sale of tooth whitening center-branded products. Such products are preferably on display in an area highly visible to the client upon leaving the tooth whitening procedure area, but prior to entering or nearing the “check-out” area where the client pays for the procedure.

Preferably, after clients' teeth have been whitened they are asked to rinse or brush away any residual whitening gel that may be remaining on the teeth using an intraprocedure brand imprinting mouthwash or dentifrice composition.

Furthermore, upon exiting the whitening station area, the client is preferably exposed to image enhancement purchase opportunities, such as maintenance toothpaste, mouthwash, toothbrushes, and other cosmetic or therapeutic products. Such products are preferably similar with respect to package design and brand identity, in order to capitalize on the brand imprinting efforts that were made during the whitening procedure. Additional image enhancement services may also be offered in this area, for example, smile insurance policies, other cosmetic dental services, and the like.

Tooth Whitening Centers, Associated Centers and Modules

In yet another embodiment of the invention, the invention provides a method for servicing the tooth whitening needs over geographical areas by providing a plurality of master tooth whitening centers (tooth whitening centers), associate centers, and satellite centers. The number of master centers, associate centers, and satellite centers depends upon the population and demand for tooth whitening in an area. Master tooth whitening centers are referred to in other places in this specification as simply “tooth whitening centers.” These terms are synonymous.

Associate centers comprise a tooth whitening “module,” that can be operated within a standard dental practice or elsewhere, such as a mall or store setting. A module performs the tooth whitening functions in associated tooth whitening centers (associate centers) in the same way as is done at master tooth whitening centers, i.e., standard operating procedures, personnel efficiencies, flow of patients, and the like.

Preferably, where non-cosmetic medical or dental treatment also takes place, modules are set up so that the tooth whitening functions performed using the module ate separate from the non-tooth whitening functions. For example, a tooth whitening service module set up in a dental practice would preferably be separate from the non-whitening oral care procedures that takes place in an ordinary dental office.

Satellite centers are established in geographical areas that already have at least one tooth whitening center or associate center, in order to take advantage of regional advertising and promotional activities regarding the nature and availability of the tooth whitening service. Satellite centers comprise only a single tooth whitening station and (generally) only a single dental professional administering the tooth whitening procedure. However, they enhance the reputation of the tooth whitening service network within the region by promoting a single brand of tooth whitening service that is common to the entire network.

Tooth whitening service modules and satellite centers are also well suited to being introduced amongst other image enhancement services. In one embodiment, the invention provides an image enhancement center that comprises a hair salon, and/or a nail salon, and a tooth whitening service module. Image enhancement centers can also comprise exercise facilities and retail shopping for products associated with image enhancement. Associate centers and satellite centers can be can be introduced into a variety of locations such as cruise ships, military and other governmental facilities, amusement parks, and destination resorts.

Associate centers provide tooth whitening using the methods and procedures of the tooth whitening service modules in the context of individual dental practices. Master tooth whitening centers and associate centers are all standardized and under the direction of one company.

Preferably, master tooth whitening centers have a plurality of associate centers within their geographical region. Master tooth whitening centers are located in regions of high population density or high demand for tooth whitening. For example, one to about ten master tooth whitening centers can be set in areas of high population and/or high demand for tooth whitening with about 25 to about 50 associate centers for each master center. The number of master tooth whitening centers and associate centers depends on the population of a geographical area and/or the potential demand in that area. For example, large regions like Los Angeles, Atlanta and New York City might have as many as fifty to one-hundred master tooth whitening centers, while a smaller market like Minneapolis might have twenty to thirty master tooth whitening centers, and even smaller market like Albany N.Y. might have one to ten master tooth whitening centers.

Preferably, master tooth whitening centers have associate centers and satellite centers within the region. The associate centers and satellite centers can also be located in the suburbs or other outlying regions. The associate centers and satellite centers follow the lead of the master tooth whitening centers which provide training for the associate and satellite centers. The associate and satellite centers benefit from the regional advertising and the brand name established by the presence of the regional centers. Preferred associate and satellite centers have a single dentist who is supplied with a prepack comprising all throw away components. A preferred prepack includes a sterilizer bag, fiber-optic positioner, pre-whitening toothbrush, pre whitening tooth paste, cheek retractor, oral napkin, syringe tips, examination/screening mirror, dental explorer, headrest cover, aspirator tip, client (patient) bib, saliva ejector, syringe tip cover, cotton rolls, gingival isolation material, mucosal isolation material (sunblock), a tooth whitening gel-whitening unit and the whitening chemistry used by the centers. Associate centers both help fulfill the demand for tooth whitening in highly populated regions and provide the benefit of tooth whitening in less populated areas.

Associate centers comprise a tooth whitening “module,” that can be operated within a standard dental practice or elsewhere, such as a mall or store setting. The module performs the tooth whitening functions in the same way as is done at master centers, i.e., standard operating procedures, personnel efficiencies, flow of clients (patients), and the like. The module provides all of the components used for tooth whitening in a master center. Preferably, where non-cosmetic medical, or dental treatment also takes place, modules are set up so that the tooth whitening functions performed using the module are separate from the non-tooth whitening functions. For example, a tooth whitening service module set up in a dental practice would be separate from the non-cosmetic oral care that takes place in an ordinary dental office.

Tooth whitening service modules and satellite centers can be set up, for example, in stores, as part of a mall, or can be included with nail salons, hair salons, a salon which includes a hair salon, a nail salon and, or in health clubs. Any marketing arrangement or set up that includes a tooth whitening service module can be referred to as an associate center.

Orthodontic patients often accumulate tooth stains around or under the orthodontia (braces, etc.) that are cosmetically unacceptable to the patient after completion of the orthodontic treatment. Thus there is a need for tooth whitening services in orthodontic dental practices. Associate centers and satellite centers can be established in orthodontic dental practices. Like all associate centers and satellite centers, these practices can evolve into tooth whitening centers if the volume of clients is sufficiently large.

The method of the invention also comprises, in a preferred embodiment, providing a central telephone number and internet web site from which a client or potential client can obtain information regarding where centers are and which center would be the closest for the client to travel to. A client or potential client can contact the central phone number or web site and be directed to the closest master tooth whitening center, associate center or satellite center. Preferably the central telephone number is toll free.

The method of the invention further comprises providing a business relationship with dentists who run the associate and satellite centers. The dentists do the same procedure as is done at the master tooth whitening centers and are charged a per procedure fee by the company. The dentist at the associate and satellite centers then charges the client their own fee to make a profit.

Preferably, the per procedure charge is implemented through the use of key cards provided by the company which dentists who run the associate or satellite center can purchase in order to buy a electronically stored inventory of procedures. To use the supplied whitening equipment, the dentist puts the key card in the machine and debits a procedure. A preferred key card provides about 5 to about 20 procedures. A preferred key card system for controlling access and usage is the Bull®SafePad® reader with Smart Card®. (Bull HN Information Systems, Inc. Integris Division, Billerica, Mass.).

The company can use the key card approach to maintain quality and standardization control of the tooth whitening methods by only providing the procedures to those dentists that maintain the standardized procedures of the invention. The standardization assures that the company can maintain the quality and efficiency of the tooth whitening method.

The arrangement of master tooth whitening, associate, and satellite centers in an area is tailored to the market in each regional area. In a preferred embodiment of the invention, the company sets up a geographical distribution of master tooth whitening, associate, and satellite centers throughout all viable geographical regions by determining the market need for tooth whitening in the different geographical regions, providing master tooth whitening centers in areas of high population density and/or great demand for tooth whitening and establishing associate tooth whitening centers in densely populated areas around master tooth whitening centers and in outlying regions.

In one embodiment, the invention provides a network comprising a dynamic interplay between satellite centers, associate centers, and master tooth whitening centers that meets the changing needs for whitening services in a geographical area. The company monitors the profitability of all types of centers to, in an ongoing way, determine whether more or less centers of each type are needed in an area. To respond to market needs, the method of the invention further comprises recruiting dentists from private practice and training dentists from private practice to run centers and establish standards. Tooth whitening personnel are also trained in how tooth whitening is carried out at the tooth whitening centers of the invention.

The network of tooth whitening centers forms a consistent service brand, much like a franchising system. The different types of centers may offer the same or a different range of services related to tooth whitening or other image enhancement procedures. Master tooth whitening centers may be used to recruit dental professionals for associated and satellite centers by conveying a stable, professional and reliable corporate brand image. The tooth whitening network is thus a dynamic system that may change over time in response to regional market needs (such as a shift in demographics or consumer preferences and tastes), but is designed for flexibility in order to fill all of the market niches for tooth whitening services.

The method makes use of economies of scale in developing market value by advertising the master tooth whitening centers and thereby creating interest at all of the master tooth whitening, associate, and satellite centers. The company sets up the infrastructure for master tooth whitening center marketing contacts, and advertising on a national level and local level. National advertising can include internet advertising. An advantage of the center/associate/satellite center interactive arrangement is that advertising costs are shared. For example, in an area with a population which could support three master tooth whitening centers, fifty associate centers, and 100 satellite centers, the company could advertise for the three master tooth whitening centers and, by virtue of this advertising, provide market benefits for the fifty associate centers and 100 satellite centers. Thus, advertising the three master centers, in addition to benefitting the fifty associate centers, the 100 satellite centers, and the parent tooth whitening service network company, also benefits the practice of the fifty dentists who run the associate centers, as well as the 100 dentists who run the satellite centers. The company monitors the profitability of master tooth whitening, associate and satellite centers to, in an ongoing way, determine whether more or fewer centers of all three types are needed in an area. To respond to market needs and establish standards, the method of the invention further comprises recruiting dentists from private practice and training dentists from private practice to run master tooth whitening centers, associate centers and satellite centers.

Cooperative Contacts

The invention provides for the generation of additional business through cooperative contacts between dentists and the tooth whitening centers. Dentist referrals result in a cooperative effect between dentists who do not provide tooth whitening services (or who cannot achieve a high level of patient satisfaction through tooth whitening techniques available to them) and the tooth whitening centers of the invention. For example, after dentists receive patient referrals from a tooth whitening center, they experience an increase in regular dental work and business for their practice. This encourages them to recommend their own patients to a tooth whitening center, further enhancing and generating a referral relationship between the tooth whitening center and the referral dentist. The cooperative effect holds true for multiple referral dentists within the vicinity of a tooth whitening center.

### EXAMPLES

### Example 1

### Large Sample Population Whitening Study

A single tooth whitening center location was chosen to gather tooth whitening data from 1000 clients, who were administered a tooth whitening procedure in accordance with the invention. The particular tooth whitening center chosen was staffed with two dental professionals and six whitening stations (DP=2 and WS=6). In order to assure uniformity and reliability of results, the tooth whitening procedure was kept essentially the same for all clients. A tooth whitening system comprising a gas plasma short arc lamp filtered so as to emit in the blue-green region of the spectrum (approximately 400-500 nanometers), together with a proprietary delivery system with a patent pending delivery device, which illuminates all smile teeth at once, was used in the study. The plasma light was used in combination with a 15% hydrogen peroxide gel buffered at an approximately neutral pH to prevent damage, which was optimized to obtain a maximal whitening effect and to ensure patient safety. The gel also contained other ingredients, such as glycerin and purified water, to prevent tooth dehydration and to further insure safety. The gel contained a proprietary photo-initiator, which assists in chromophore destruction at the tooth surface. Teeth whitening was performed using a standardized procedure, which is briefly described below:

Tooth Whitening Procedure

The suitability of the patient to undergo teeth whitening is determined using a standard dental medical history followed by a clinical examination of the patients mouth and oral tissues. Not all patients are considered to be suitable cases to under go teeth whitening. The most common dental reasons for rejection include: Carious lesions, Broken or lost restorations, Crowns or laminates on anterior teeth, periodontal disease, and extensive calculus.

The tooth whitening procedure required approximately 90 minutes and comprised the following steps:
pre-treatment tooth color was measured using a VITAPAN™ System shade guide;
the patient brushed his or her teeth with a special pre-whitening toothpaste to remove loose debris and stain (note: some of the acquired pellicle is removed on brushing);
a cheek retractor was placed to expose all smile line upper and lower teeth;
the patient bit down on a special fiber-optic positioning device;
a standard light cured isolation material was placed on gingival or gum tissues;
the peroxide gel was placed onto the tooth surfaces;
the teeth were illuminated with the light for twenty minutes;
the above two steps were repeated for a total exposure time of one hour;
check retractors etc. were removed;
patient brushed and rinsed residual gel from mouth; and finally
post-treatment shade was measured.

All patients were treated at consistent illumination levels. The light energy was controlled using a specially designed “fiber optic positioner” which maintained a constant distance between the patient's teeth and the light source. Tooth shade was measured by the same dental professionals in order to avoid inter-investigator variability. Attempts were made to keep the ambient light conditions the same. The VITAPANT™ shade guide was ordered in terms of brightness as recommended by the manufacture, and the shade improvement was calculated by counting the tabs. The data was collected by a chart review by an individual not involved in the clinical procedures of the first 1000 cases. For the purposes of this study all cases of intrinsic tooth staining were included with the exception of tetracycline stain.

Summary of Results

Shade change analysis of the first 1000 non-tetracycline cases performed at the tooth whitening center showed an average improvement of 7.8 shades. The results showed that the darker the teeth the greater the whitening effect. An average shade improvement of 8.8 tabs was observed for cases who were darker than the average tooth color (A3 and darker). This group of patients required a change of at least eight shades to reach their maximum potential tooth whiteness, i.e., the top of the whitening scale. The average pretreatment shade of the first 1000 cases was D3 54% of all cases reached the top of the scale as measured immediately post-treatment, 74% of patients achieved results of A1 or better (one shade from the top). 85% of patients achieved B2 or better (two shades from the top of the scale). 22% of all patients achieved 9 shades or more. 53% of patients achieved 7.5 shades or more.

An examination of the data also showed that substantial whitening was achieved when the results for all pre-treatment shade groups were pooled and averaged (average pre-treatment shade was D3, average shade improvement was 7.8).

Additionally, when the results for each pre-treatment shade group were treated separately and averaged, see Table V below, the goal of substantial whitening was also met.

TABLE V
Individual Pre-Treatment Shade Group Results

| | | | Minimum | |
|---|---|---|---|---|
| | | | Shade | |
| Pre- | | Maximum | Changes | |
| treatment | Number of | Potential Shade | Required for | Average |
| Shade | Clients in | Change | Substantial | Whitening for |
| Group | Group | Improvement | Whitening | Group |
| C4 | 33 | 16 | 8 | 10.18 |
| A4 | 60 | 15 | 8 | 10.94 |
| C3 | 34 | 14 | 7 | 10.35 |
| B4 | 50 | 13 | 7 | 9.40 |
| A3.5 | 115 | 12 | 6 | 9.28 |
| B3 | 94 | 11 | 6 | 9.02 |
| D3 | 115 | 10 | 5 | 8.07 |
| A3 | 205 | 9 | 5 | 7.71 |
| D4 | 71 | 8 | 4 | 6.68 |
| C2 | 64 | 7 | 4 | 6.06 |
| C1 | 49 | 6 | 3 | 5.28 |
| A2 | 63 | 5 | 3 | 4.52 |
| D2 | 10 | 4 | 2 | 3.40 |
| B2 | 17 | 3 | 2 | 2.79 |
| A1 | 12 | 2 | 1 | 2.00+ (off-scale) |
| B1 | 8 | 1 | 1 | 1.00+ (off-scale) |

The results in Table V demonstrate that substantial whitening was achieved in all of the pre-treatment shade groups in the study.

### Example 2

### Comparison of Invention to Conventional Dental Office Method

The efficiencies and tooth whitening capabilities of the inventive business method were compared to the method of offering tooth whitening services in a conventional dental office. In a conventional dental office method, a single dental professional can typically administer a tooth whitening service to only one patient at a time. In the inventive method, multiple clients can be whitened simultaneously by a single dental professional. The improvement in dental professional work hours required to efficiently whiten the teeth of a large number of clients per 8-hour day is demonstrated in Table VI below. The comparison assumes the use of the same tooth whitening procedure (procedure time=60 minutes, average shade change=8) in both methods. The comparison also assumes the simultaneous whitening of clients, whenever possible, in the inventive method. The lower the number of dental professional hours required per shade change, the more efficient the method of offering the tooth whitening service.

TABLE VI
Comparison of Dental Professional Work Hour Per
Shade Change Efficiencies

Dental Professional Work Hours/Shade

| Number of Clients | Conventional Dental | Inventive Method |
|---|---|---|
| per 8-hour Day | Office Method | (DP = 1, WS = 2) |
| 1 | 0.1250 | 0.1250 |
| 2 | 0.1250 | 0.0625 |
| 3 | 0.1250 | 0.0833 |
| 4 | 0.1250 | 0.0625 |
| 5 | 0.1250 | 0.0750 |
| 6 | 0.1250 | 0.0625 |
| 7 | 0.1250 | 0.0714 |
| 8 | 0.1250 | 0.0625 |
| 9 | Not feasible | 0.0694 |
| 10 | Not feasible | 0.0625 |
| 11 | Not feasible | 0.0682 |
| 12 | Not feasible | 0.0625 |
| 13 | Not feasible | 0.0673 |
| 14 | Not feasible | 0.0625 |
| 15 | Not feasible | 0.0667 |
| 16 | Not feasible | 0.0625 |

Since the simultaneous tooth whitening of two or more clients by a single dental professional is not possible in a conventional dental office setting, it is only feasible to treat a limited number of clients per 8-hour day (per dental professional and per whitening station). The above Table clearly demonstrates the efficiencies obtained when two or more clients obtain tooth whitening services through the inventive method. In addition, the Table also shows the limitations of prior art methods (a conventional dental office) in offering tooth whitening services to a plurality of clients.

Thus, while there have been described what are presently believed to be the preferred embodiments of the invention, those skilled in the art will realize that other and further embodiments can be made without departing from the spirit of the invention, and it is intended to include all such further modifications and changes as come within the true scope of the claims set forth herein.

1-39. (canceled)

40. A method of providing light-activated, tooth whitening services to a plurality of clients by one dental professional, which comprises:
(a) providing a light-activated tooth whitening module comprising at least two light-activated, tooth whitening workstations, each workstation in the module being operated by the dental professional;
(b) assigning each client to a workstation of the module; and
(c) having the dental professional administer light-activated, tooth whitening services to each client in each workstation of the module,
wherein at least a portion of the light-activated, tooth whitening procedure is provided to each client simultaneously.

41. The method according to claim 40, further comprising evaluating clients prior to administering light-activated, tooth whitening services.

42. The method according to claim 41, wherein clients are evaluated at a location physically removed from the workstations.

43. The method according to claim 41, wherein the step of evaluating comprises examining clients to determine their suitability for undergoing light-activated, tooth whitening.

44. The method according to claim 43, wherein the step of evaluating comprises comparing shades in a shade guide to the shade of the client's teeth and choosing a desired shade as a goal for treatment.

45. The method according to claim 40, which further comprises priming the teeth of the clients prior to administering light-activated, tooth whitening services.

46. The method according to claim 45, wherein the step of priming the teeth of the clients comprises brushing the teeth of each of the clients with a prewhitening dentifrice.

47. The method according to claim 40, wherein light-activated, tooth whitening services comprises substantially whitening cosmetically visible teeth of a client.

48. The method according to claim 47, wherein the teeth are substantially whitened in less than about two hours.

49. The method according to claim 47, wherein the teeth are substantially whitened in less than about ninety minutes.

50. The method according to claim 47, wherein the teeth are substantially whitened in less than about sixty minutes.

51. The method according to claim 40, wherein a whitening productivity coefficient of greater than about 32 is obtained.

52. The method according to claim 40, wherein a whitening productivity coefficient of greater than about 96 is obtained.

53. The method according to claim 40, wherein a whitening productivity coefficient of greater than about 192 is obtained.

54. The method according to claim 41, wherein evaluating clients is done in an examination chair.

55. The method according to claim 46, wherein the prewhitening dentifrice has organoleptic properties designed to be pleasing to a client.

56. A method of providing light-activated, tooth whitening services to a plurality of clients by one dental professional, which comprises:
(a) providing a light-activated tooth whitening module comprising at least two light-activated, tooth whitening workstations, each workstation in the module being operated by the dental professional;
(b) assigning each client to a workstation of the module; and
(c) having the dental professional administer light-activated, tooth whitening services to each client in each workstation of the module,
wherein the light-activated, tooth whitening services comprises the steps of:
(i) applying a whitening gel to all of the cosmetically visible teeth of the client;
(ii) applying light to all of the teeth simultaneously for a fixed period of time; and
(iii) repeating steps (i) and (ii) two to five times.

57. The method accordingly to claim 56, wherein light is applied to the teeth simultaneously for a fixed period of time of about 15 to about 30 minutes.

58. The method accordingly to claim 56, wherein light is applied to the teeth simultaneously for a fixed period of time of about 20 minutes.

59. The method accordingly to claim 56, wherein steps (i) and (ii) are repeated three times.

60. The method according to claim 56, further comprising a step of isolating the teeth of the client from gingival tissue prior to the step of applying whitening gel.

61. The method according to claim 60, wherein isolating the teeth of the client comprises applying a suitable isolation material.

62. The method according to claim 56, further comprising a step of priming of the teeth of the client prior to the step of applying the whitening gel.

63. The method according to claim 62, wherein priming comprises brushing the teeth of the client with a pre-whitening dentifrice.

64. The method according to claim 56, further comprising a step of comparing the shade of teeth to a desired shade on a shade guide.

65. The method according to claim 56, wherein the whitening gel comprises from about 1% to about 35% hydrogen peroxide.

66. The method according to claim 56, wherein the whitening gel comprises from about 5% to about 35% hydrogen peroxide.

67. The method according to claim 56, wherein the whitening gel comprises from about 3% to about 20% hydrogen peroxide.

68. The method according to claim 56, wherein the whitening gel comprises from about 6% to about 15% hydrogen peroxide.

69. The method according to claim 56, wherein the whitening gel comprises an oxidizing compound.

70. The method according to claim 69, wherein the oxidizing compound is selected from the group consisting of hydrogen peroxide, carbamide peroxide, calcium peroxide, sodium perborate, potassium persulfate, peracetic acid, metal peroxides, alkali metal percarbonates, and alkali metal perborates.

71. The method according to claim 70, wherein the oxidizing compound comprises hydrogen peroxide.

72. The method according to claim 70, wherein the oxidizing compound comprises hydrogen peroxide and carbamide peroxide.

73. The method according to claim 69, wherein the oxidizing compound comprises a peroxyacid compound.

74. The method according to claim 73, wherein the peroxyacid compound is selected from the group consisting of peroxyacetic acid and a peroxyacid precursor compound.

75. The method according to claim 74, wherein the peroxyacid precursor compound is selected from the group consisting of glyceryl triacetate, an acetylated amino acid, acetylsalicylic acid, N,N,N′,N′-tetraacetyl ethylenediamine, a vinyl acetate polymer, a vinyl acetate copolymer, acetylcholine, and other biologically acceptable acetylated compounds.

76. The method according to claim 56, wherein the whitening gel comprises a photosensitizing agent.

77. The method according to claim 76, wherein the photosensitizing agent is selected from the group consisting of a semiconductor particle, a benzophenone derivative, a benzotriazole derivative, a diketone, a metal-ligand complex, and a phthalocyanin-metal complex.

78. The method according to claim 77, wherein the photosensitizing agent comprises a semiconductor particle selected from the group consisting of titanium dioxide and zinc oxide.

79. The method according to claim 77, wherein the photosensitizing agent comprises a diketone selected from the group consisting of camphorquinone and benzil.

80. The method according to claim 77, wherein the photosensitizing agent comprises a metal-ligand complex selected from the group consisting of ferric potassium oxalate, manganese gluconate, ethylenediamine tetraacetic acid, diethylenetriamine pentaacetic acid, nitrilotriacetic acid, 1-hydroxyethylidene-1,1-diphosphonic acid, ethylenediamine tetra(methylenephosphonic acid), diethylenetriamine penta(methylenephosphonic acid), sorbitol, xylitol, mannitol, maltitol, and lactitol.

81. The method according to claim 56, wherein the whitening gel comprises an oxidizing compound and a photosensitizing agent.

82. The method according to claim 81, wherein the oxidizing compound comprises hydrogen peroxide and the photosensitizing agent comprises ethylenediamine tetraacetic acid.

83. The method according to claim 56, further comprising the step of treating the teeth with a desensitizing composition after steps (i) and (ii) are repeated two to five times.

84. The method according to claim 83, wherein the desensitizing composition comprises at least one of potassium nitrate and fluoride.

85. The method according to claim 83, wherein the desensitizing composition comprises from about 3% to about 6% potassium nitrate by weight of the composition.

86. The method according to claim 56, wherein the whitening gel has organoleptic properties designed to be pleasing to a client.

87. The method according to claim 61, wherein the isolation material has organoleptic properties designed to be pleasing to a client.

88. The method according to claim 56, wherein the workstation comprises at least one chair, a tooth whitening procedure tray, and a light source.

89. The method according to claim 88, wherein the workstation further comprises entertainment.

90. The method according to claim 88, wherein the tooth whitening procedure tray comprises a pre-whitening toothbrush, a pre-whitening tooth paste, a cheek retractor, a gingival isolation material, and the whitening gel.

91. The method according to claim 90, wherein the tooth whitening procedure tray optionally further comprises a sterilized bag, a fiber-optic positioner, an oral napkin, at least one syringe tip, an examination/screening mirror, a dental explorer, a headrest cover, an aspirator tip, a client bib, a salvia ejector, a syringe tip cover, at least one cotton ball, and a mucosal isolation material.

92. The method according to claim 90, wherein the tooth whitening gel is stored separately from the other components on the tray.

93. The method according to claim 88, wherein the tooth whitening tray is sterilized.

94. The method according to claim 88, wherein the light source is selected from the group consisting of gas plasma, light emitting diode, linear flash lamp, tungsten halogen, metal halide, Xenon short arc, Mercury short arc, Mercury Xenon short arc, Argon plasma arc, and Argon short arc lamps.

95. The method according to 94, wherein the light source is a plasma arc lamp.

96. The method according to 94, wherein the light source is a metal halide lamp.
